(19) United States
(12) Patent Application Publication
(10) Pub. No.: US 2013/0135438 A1
(43) Pub. Date: May 30, 2013

(54) GATE CONTROL SYSTEM AND METHOD

(71) Applicants: HOU-HSIEN LEE, Tu-Cheng (TW); CHANG-JUNG LEE, Tu-Cheng (TW); CHIH-PING LO, Tu-Cheng (TW)

(72) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/604,703

(22) Filed: Sep. 6, 2012

(30) Foreign Application Priority Data
Nov. 29, 2011 (TW) 100143823

(51) Int. Cl. H04N 13/02

(52) U.S. Cl. 348/46; 348/E13.074

(57) ABSTRACT

A gate control system includes a system control unit, a gate device, and an image obtaining unit. The system control unit further includes a gate control unit and a determination unit. The image obtaining unit captures image of a scene in an operating area of the gate device and obtains distance information. The gate control unit generates three dimension data according to the captured images and the distance information, and the determination unit determines according to the three dimension data whether a person has passed through the gate device. The system control unit controls the gate device according to the determination unit. The disclosure further provides a gate control method.

### BACKGROUND

1. Technical Field

The present disclosure relates to a gate control system and a gate control method, and particularly to a gate control system and a gate control method for an automatic ticket gate.

2. Description of Related Art

An automatic gate can be installed in a station, an airport, or other places. The automatic gate can restrict passage only to people who provide a token, such as a coin, a ticket, or a pass, for example. After the token has been provided, a control system of the gate determines whether a person has passed through the gate or not by means of a device, such as an infrared ray sensor. For example, the control system determines that a person is passing, when a reflected beam of a light beam from the infrared ray sensor is obstructed. Then, the control system determines that the person has passed through the gate when the obstruction of the reflected beam is over. However, the control system may make an incorrect determination and close the gate when baggage or other objects obstruct the reflected beam and then their owner takes them from the reflected beam. Consequently, the person cannot pass the gate successfully.

Therefore, there is need for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a gate control system of the present disclosure.

FIG. 2 is a view of an embodiment of a gate control system of the present disclosure.

FIG. 3 is an operating diagram of the gate control system in FIG. 2.

FIG. 4 is a block diagram of an embodiment of a system control unit of a gate control system of the present disclosure.

FIG. 5 is a block diagram of an embodiment of a determination unit of a gate control system of the present disclosure.

FIG. 6 is a flowchart of an embodiment of a gate control method of the present disclosure.

### DETAILED DESCRIPTION

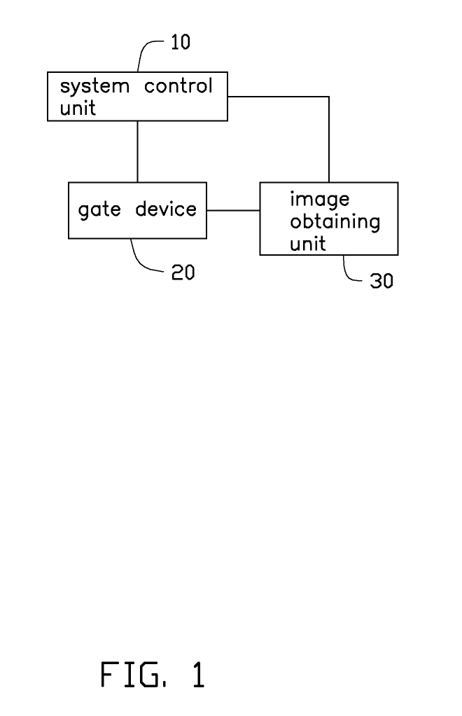

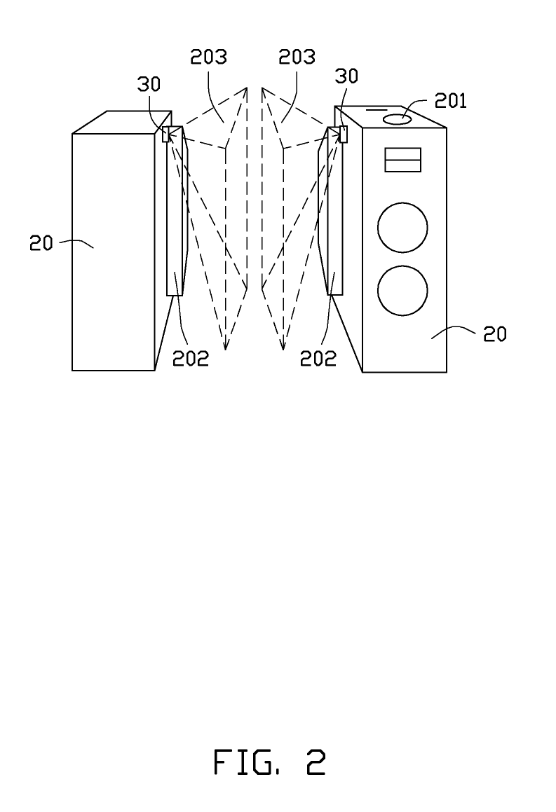

As shown in FIG. 1, an embodiment of a gate control system includes a system control unit 10, a gate device 20, and an image obtaining unit 30. As shown in FIG. 2, the gate control system includes two gate devices 20, and two image obtaining units 30. Each of the image obtaining units 30 is installed on each of the gate devices 20. Each of the gate devices 20 further includes a door 202, and one of the gate devices 20 further includes an authentication unit 201. In addition, an operating area 203 of the gate devices 20 is sandwiched between the gate devices 20.

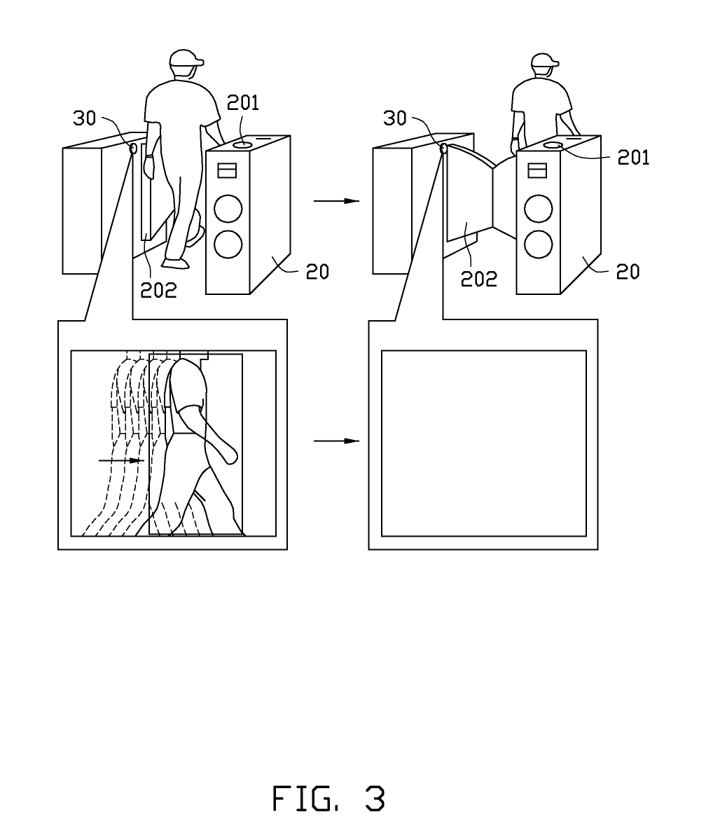

As shown in FIG. 2 and FIG. 3, the image obtaining unit 30 captures images of the scene in the operating area 203 and obtains distance information including distances between points on an object in the operating area 203 and the image obtaining unit 30. In the embodiment, the distance information is included in the captured images. In the embodiment, the image obtaining unit 30 can be a depth-sensing camera, such as a time-of-fight (TOF) camera. The TOF camera can emit a signal with a particular wavelength when capturing the image. When the signal reaches the object, the signal is reflected and then is received by the TOF camera. The difference between the emitting time and the receiving time is directly proportional to the distance between the object and the TOF camera. Thereby, the TOF camera can obtain the distance information indicating distances between points on an object and the image obtaining unit 30. In other embodiments, the image obtaining unit 30 can be selected from cameras with the function of depth determination.

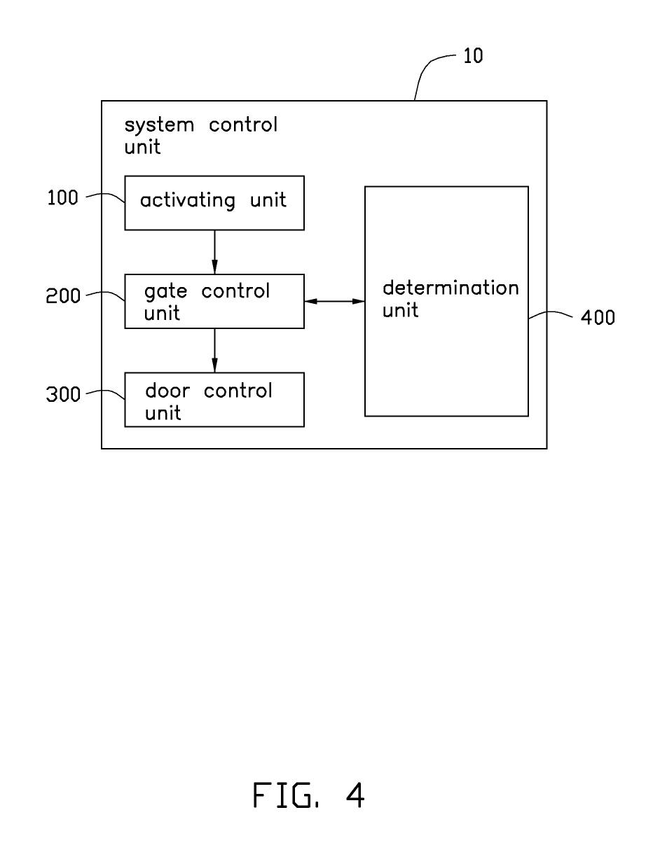

As shown in FIG. 4, the system control unit 10 of the gate control system includes an activating unit 100, a gate control unit 200, a door control unit 300, and a determination unit 400. The activating unit 100 controls the image obtaining unit 30 to obtain the captured images and the distance information, and transmits the captured images and the distance information to the gate control unit 200. The door control unit 300 controls the door 202 to open or close.

The gate control unit 200 generates three dimension (3D) data according to the captured images and the distance information, and transmits the 3D data to the determination unit 400. In addition, the gate control unit 200 compares an opened time of the door 202 with a predetermined time, wherein the predetermined time is a limited time, allowing a person to pass through the door 202. When the opened time reaches the predetermined time, the gate control unit 200 controls the door control unit 300 to close the door 202. In addition, the gate control unit 200 authenticates a token when the authentication unit 201 receives the token of a user. When the gate control unit 200 authenticates the token, the gate control unit 200 controls the door control unit 300 to open the door 202. Then, the determination unit 400 determines whether the object in the operating area 203 is a human body of a person or not according to the 3D data, and transmits the results of the determination to the gate control unit 200.

In the embodiment, the distance information of the captured images can be transferred as distance pixel values, wherein the maximum distance information corresponds to the distance pixel value “255” and the minimum distance information corresponds to the distance pixel value “0”. The gate control unit 200 combines the captured images and the distance pixel values of the points on the object to form image arrays, i.e. the 3D data. In other embodiments, the 3D data can be a 3D image constructed through the image arrays for comparison.

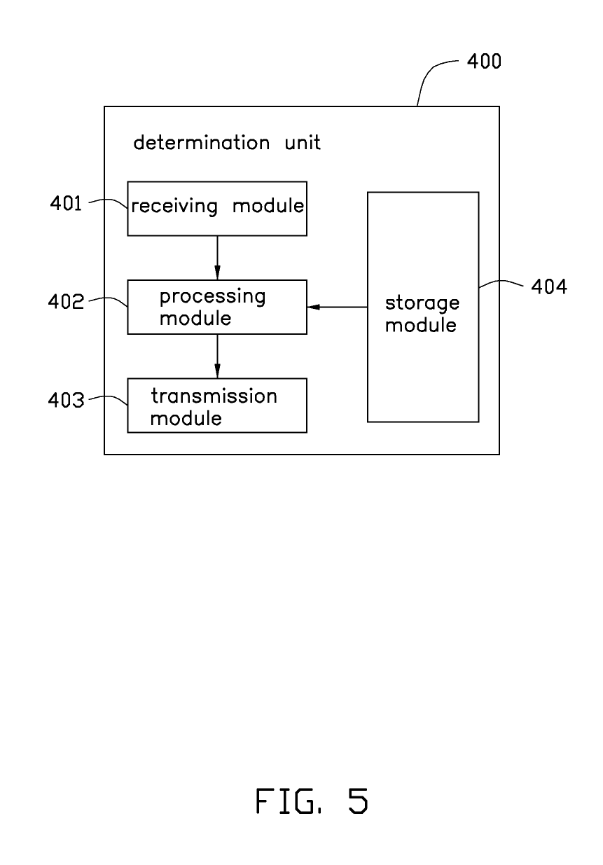

As shown in FIG. 5, the determination unit 400 of the system control unit 10 includes a receiving module 401, a processing module 402, a transmission module 403, and a storage module 404. The receiving module 401 receives the 3D data from the gate control unit 200. The storage module 404 stores a plurality of 3D human models. The 3D human models can also be 3D data of humans being captured by the image obtaining unit 30 in advance.

The processing module 402 compares the 3D data from the gate control unit 200 with the 3D human models. When the 3D data is similar to one of the 3D human models, the processing module 402 determines that the object is a human body and that there is a person in the operating area 203. Then, the processing module 402 transmits a positive signal as the comparison result to the gate control unit 200 by the transmission module 403. When the 3D data is different from all of the 3D human models, the processing module 402 determines that there is no person in the operating area 203. Then, the processing module 402 transmits a negative signal as the comparison result to the gate control unit 200 by the transmission module 403.

In the embodiment, the image obtaining unit 30 may not be able to capture an image of the whole human body since an installed position of the image obtaining unit 30 is limited by a height of the gate device 20. Thus, the gate control system can restrict a compared range of each of the 3D human models to correspond to the size of the captured images of the image obtaining unit 30. For example, the compared range is 70%-80% size of each of the 3D human models. In other embodiments, if the 3D human models are also obtained by the image obtaining unit 30 on the gate device 20, the processing module 402 can directly compare the 3D data with the 3D human module without limiting the size of the 3D human models.

In the embodiment, the processing module 402 uses the image arrays to compare with the 3D human models, wherein the 3D human models also include distance pixel values. In addition, a point of the image arrays is only compared with a point of each of the 3D human models, wherein a position of the compared point in the image array is the same as a position of the compared points of the 3D human models. If a percentage of a difference between a distance pixel value of the compared point in the image array and a distance pixel value of the compared point in a 3D human model is less than a first predetermined percentage, such as 5%, the processing module 402 determines that the compared point in the image array is similar to the compared point of the 3D human model. If a percentage of the similar points of the image array is more than a second predetermined percentage, such as 85% and 90%, the processing module 402 determines that the image array is similar to the 3D human model. In other embodiments, the 3D human models can also be 3D image models to be compared with the 3D images constructed through the image arrays of the captured images.

As shown in FIGS. 2-5, the image obtaining unit 30 and the door 202 are installed on a side wall of the gate device 20. The gate control unit 200 controls the door control unit 300 to open the door 202 when the gate control unit 200 has authenticated the token of the user received by the authentication unit 201. At the same time, the gate control unit 200 controls the image obtaining unit 30 to capture the images of the scene in the operating area 203 through the activating unit 100. The image obtaining unit 30 transmits the captured images and the distance information to the gate control unit 200 through the activating unit 100. Then, the gate control unit 200 generates the 3D data according to the captured images and the distance information, and transmits the 3D data to the receiving module 401 of the determination unit 400. The receiving module 401 transmits the 3D data to the processing module 402. The processing module 402 receives the 3D human models from the storage module 404 and compares the 3D data with the 3D human models.

When the 3D data is different from all of the 3D human models, the processing module 402 determines that the object is not a human body and that there is no person in the operating area 203. Then, the processing module 402 transmits a negative signal as the comparison result to the gate control unit 200 by the transmission module 403. The gate control unit 200 receives the negative signal and keeps generating the 3D data for the determination unit 400 to determine whether there is a person in the operating area 203 or not.

When the 3D data is similar to one of the 3D human models, the processing module determines 402 that the object is a human body and that there is a person in the operating area 203. Then, the processing module 402 transmits a positive signal as the comparison result to the gate control unit 200 by the transmission module 403. The gate control unit 200 receives the negative signal and keeps generating the 3D data for the determination unit 400 to determine whether the person leaves the operating area 203 or not. Then, the processing module 402 determines that the person has left the operating area 203 when the determination unit 400 determines that the 3D data is different from all of the 3D human models. Thus, the gate control unit 200 can control the door control unit 300 to close the door 202.

The gate control unit 200 further compares the opened time of the door 202 with the predetermined time. If the opened time reaches the predetermined time, the gate control unit 200 controls the door control unit 300 to close the door 202. If the opened time is smaller than the predetermined time, the gate control unit 200 keeps the door 202 open and keeps generating the 3D data for the determination unit 400 to determine whether the person leaves the operating area 203 or not or to determine if there is a person in the operating area 203.

When the door 202 is closing, there is an operative area of the door 202. The operative area is an area which the door 202 will pass through during opening and closing. In addition, the door 202 will not be closed if the gate control system determines that the person may hurt due to the opening and closing of the door 202. In other words, the door 202 can be closed when the person is not within the operative area of the door 202. For example, the person has walked across the door 202 although the person is still in the operating area of the gate device 20. Therefore, the gate control system can further determine the relative position between the person and the door 202 to keep the person safe when the opened time reaches the predetermined time.

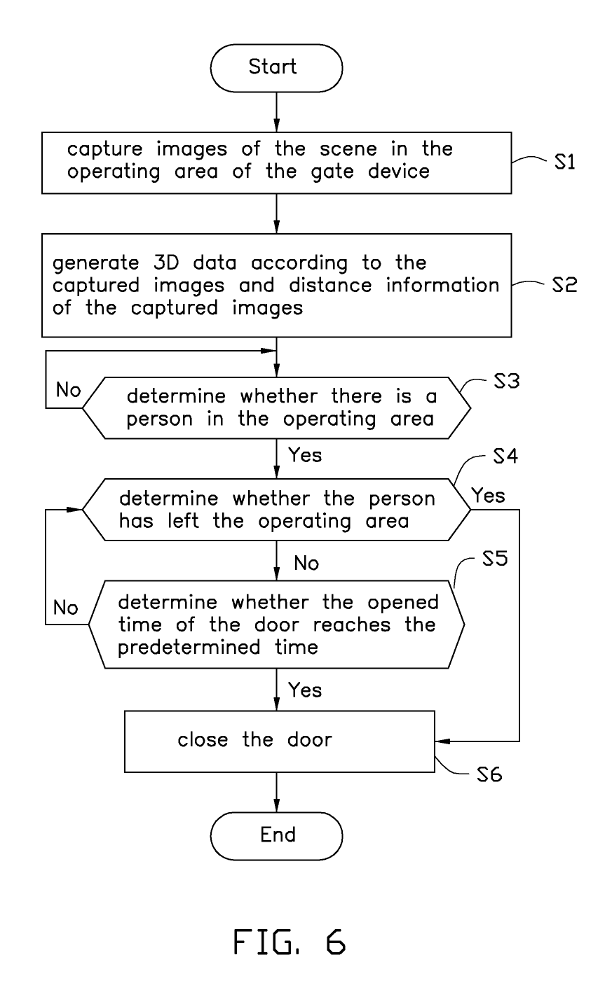

As shown in FIG. 6, an embodiment of the gate control method is as follows:

In step S1, the gate control unit 200 authenticates a token of a user received by the authentication unit 201 of the gate device 20, and controls the door control unit 300 to open the door 202 if the token is authenticated. The gate control unit 200 controls the image obtaining unit 30 through the activating unit 100 to capture images of a scene in the operating area of the gate device 20. Each of the captured images includes distance information including distances between points on an object in the operating area 203 and the image obtaining unit 20.

In step S2, the gate control unit 200 receives the captured images and the distance information, and generates 3D data according to the captured images and the distance information. Then, the gate control unit 200 transmits the 3D data to the determination unit 400.

In step S3, the receiving module 401 of the determination unit 400 receives the 3D data from the gate control unit 200. The processing module 402 receives the 3D data from the receiving module 401 and the 3D human models from the storage module 404, and compares the 3D data with the 3D human models to determine whether the object in the operating area 203 is a human body of a person.

If the object is not a human body, processing module 402 determines that there is no person in the operating area 203 at that time, and keeps determining whether the object is a human body. If the object is a human body of a person, the processing module 402 determinates that there is a person in the operating area 203, and the procedure goes to step S4.

When the 3D data is similar to one of the 3D human models, the processing module 402 transmits a positive signal as the comparison result to the gate control unit 200 by the transmission module 403. When the 3D data is different from all of the 3D human models, the processing module 402 transmits a negative signal as the comparison result to the gate control unit 200 by the transmission module 403. The gate control unit 200 determines whether there is a person in the operating area 203 according to the comparison result of the processing module 402. Thus, the gate control unit 200 can determine that there is a person in the operating area 203, when the gate control unit 200 receives the positive signal.

In step S4, the processing module 402 determines whether the person has left the operating area 203 or not. If the person has left the operating area 203, the procedure goes to step S6. If the person is still in the operating area 203, the procedure goes to step S5.

The gate control unit 200 keeps receiving the captured images and the distance information to generate new 3D data in step S4. When the new 3D data is different from all of the 3D human models, the processing module 402 determines that the person has left the operating areas 203. In contrast, the processing module 402 determines that the person is still in the operating area 203 when the new 3D data is still similar to one of the 3D human models.

In step S5, the gate control unit 200 determines whether the opened time of the door 202 reaches the predetermined time. When the opened time reaches the predetermined time, the procedure goes to step S6. When the opened time is smaller than the predetermined time, the procedure goes to step S4.

In step S6, the gate control unit 200 controls the door control unit 300 to close the door 202. In other embodiments, the door 202 can be closed when the opened time reaches the predetermined time, even if the processing module 402 determines that there is no person in the operating area 203. In addition, the gate control system can further check whether the person in the operating area 203 is safe when the door 202 is closing or not.

The above gate control system and method is operated by using the image obtaining unit 30 to capture the image of the scene in the operating area 203 of the gate device 20 for determining whether a person has passed through the gate device 20. In addition, the gate control unit 200 can control the door 202 through the door control unit 300 according to the determination when a person has passed through the gate device 20. Thus, a wrong determination due to an access of the bag can be prevented. Accordingly, the number of wrong determination of the gate control system can be decreased, and a correct rate of the gate control system for determining whether a person has successfully passed through the gate device 20 can be increased. In addition, the gate control unit 200 can close the door 202 through the door control unit 300 when the opened time of the door 202 reaches the predetermined time. In other words, the gate control system and method further restrict passage within a limited time by setting the predetermined time of the door 202. Thus, people can pass the door 20 quickly, and when number of people waiting to pass is very high, the efficiency of the gate device 20 is increased.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A gate control system, comprising:
a gate device comprising a door;
an image obtaining unit configured to capture images of an operating area of the gate device, each of the captured images comprising a distance information including distances between the image obtaining unit and points on an object in the operating area; and
a system control unit, comprising:
a gate control unit configured to authenticate a token and to generate three-dimension (3D) data according to the captured images and the distance information;
a determination unit configured to determine, according to the 3D data, whether the object is a person; and
a door control unit configured to control the door according to the determination unit and the authentication of the gate control unit.

2. The gate control system of claim 1, wherein the system control unit comprises:
an activating unit configured to activate the image obtaining unit to capture the images when the token is authenticated.

3. The gate control system of claim 1, wherein the door control unit opens the door when the token is authenticated and closes the door when the person leaves the operating area.

4. The gate control system of claim 1, wherein the gate control unit determines whether an opened time of the door reaches a predetermined time, and controls the door control unit to close the door when the opened time reaches the predetermined time.

5. The gate control system of claim 1, wherein the determination unit comprises:
a receiving module configured to receive the 3D data from the gate control unit;
a storage module configured to store a plurality of 3D human models; and
a processing module configured to compare the 3D data with the 3D human models to determine whether the object is a person, and to transmit a comparison result to the gate control unit by a transmission module.

6. The gate control system of claim 5, wherein the processing module determines that the object is a person when the 3D data is similar to one of the 3D human models, and then a positive signal is transmitted as the comparison result to the gate control unit.

7. The gate control system of claim 5, wherein the processing module determines that the object is different from a person when the 3D data is different from all of the 3D human models, and then a negative signal is transmitted as the comparison result to the gate control unit.

8. The gate control system of claim 1, wherein the image obtaining unit is a depth-sensing camera.

9. The gate control system of claim 8, wherein the depth-sensing camera is a time of flight camera.

10. The gate control system of claim 1, wherein the gate device comprises an authentication unit to receive the token.

11. A gate control method for controlling a gate device having a door, comprising:
using an image obtaining unit to capture images of an operating area of the gate device when the door is opened, each of the captured images comprising a distance information including distances between points on an object and the image obtaining unit;
generating three dimension (3D) data according to the captured images and the distance information;
determining whether the object is a person according to the 3D data; and
controlling the door according to the determination.

12. The gate control method of claim 11, comprising:
comparing an opened time of the door with a predetermined time; and
closing the door when the opened time reaches the predetermined time.

13. The gate control method of claim 11, comprising:
determining whether the person leaves the operating area when the object is a person; and
closing the door when the person leaves the operating area.

14. A gate controller for controlling a gate device, the gate controller comprising:
a door control unit configured to control the gate device;
a gate control unit configured to receive a plurality of images and distance information and to generate a three dimension (3D) data according to the images and the distance information; wherein the images are captured by an image obtaining unit, and each of the images comprises the distance information including distances between the image obtaining unit and points on an object in an operating area of the gate device; and
a determination unit configured to determine, according to the 3D data, whether the object is a person and to control the door control unit according to the determination.
